(19) United States
(12) Patent Application Publication
(10) Pub. No.: US 2005/0114528 A1
(43) Pub. Date: May 26, 2005

(54) System, server, method and program for providing communication service

(75) Inventor: Akiko Suito, Tokyo (JP)

Correspondence Address: MCGINN & GIBB, PLLC, 8321 OLD COURTHOUSE ROAD, SUITE 200, VIENNA, VA, 22182-3817, US

(73) Assignee: NEC Corporation, Tokyo (JP)

(21) Appl. No.: 10/989,075

(22) Filed: Nov. 16, 2004

(30) Foreign Application Priority Data
Nov. 20, 2003 (JP) 390129/2003

(51) Int. Cl. G06F 15/16

(52) U.S. Cl. 709/228; 709/246

(57) ABSTRACT

A system for providing communication service includes a communication server, a plurality of user terminals connected to the communication server via a communication network, a connection management unit, a service control unit and a data generating unit. The connection management unit detects information about an operation environment of each of the plurality of user terminals. The service control unit analyzes a meaning of a communication operation received from one of the plurality of user terminals, and determines an applicable data format used for transmitting the communication operation to another of the plurality of user terminals according to the operation environment of the other user terminal. The data generating unit generates transmission data to be provided for the other user terminal based on the applicable data format determined by the service control unit.

### BACKGROUND OF THE INVENTION

1. Field of the Invention

The present invention relates to a communication service providing system, a communication service providing method and a communication service providing program for providing two-way communication service. In particular, the present invention relates to a communication service providing system, a communication server, a communication service providing method and a communication service providing program for two-way communication between a plurality of terminals having different performance.

2. Description of the Related Art

In these days, lots of two-way communication services are provided, which enable a plurality of users at remote locations to communicate with each other via a communication network. According to the two-way communication in which the users use respective user terminals, the respective users generally synthesize a plurality of communication functions (a data sharing function, a video data exchange function, an audio data exchange function and so on) and communicate with each other by watching respective terminal screens displaying the same information. Also, the two-way communication service is expected to provide services which are not limited by time and place by utilizing mobile terminals (portable IT devices) such as a cell phone and a PDA (Personal Digital Assistance).

Japanese Laid Open Patent Application (JP-P2002-324038A; Patent document 1) discloses a system regarding the two-way communication service. The system is intended to establish an appropriate communication by automatically searching user terminals connected to a server for user terminals having the same performance and then connecting the user terminals having the same performance with each other.

Japanese Laid Open Patent Application (JP-P2000-122957A; Patent document 2) discloses a system intended to establish a smooth communication. According to the system, when a user communicates with another user by using a user terminal A and data which can not be displayed or played come up, another user terminal B which can display or play the data takes over the communication.

Japanese Laid Open Patent Application (JP-P2003-167854A; Patent document 3) discloses an equipment for providing a service according to environments for the usage. The equipment converts quality level of contents such as an image, a video and an audio based on the user authentication.

Japanese Laid Open Patent Application (JP-P2002-7296A; Patent document 4) discloses a method for establishing a optimum communication by converting data displayed on a screen according to environments of another user terminal when the other user terminal is in an online state.

Japanese Laid Open Patent Application (JP-P2000-148647A; Patent document 5) discloses a method of providing a most suitable expression by converting contents of the expression on a screen by using a style template prepared for every terminal.

Japanese Laid Open Patent Application (JP-P2002-63108A; Patent document 6) discloses an information processing system. The information processing system consists of an information terminal and a gateway server. The information terminal transmits a request for acquiring contents to the gateway server via a communications line. In response to the request, the gateway server transmits the request to a Web server storing contents information and receives the contents associated with the request from the Web server. Then, the gateway server converts the received contents according to a screen size and display performance of the information terminal. The information terminal receives appropriate contents generated by the conversion.

Japanese Laid Open Patent Application (JP-P2003-153223A; Patent document 7) discloses a collaboration service providing system. In the collaboration service providing system, quality levels of audio data and moving picture data can be selected according to importance of collaboration and a communication environment at the time of holding of the collaboration. The collaboration can be held in an appropriate condition that participants satisfy.

Japanese Laid Open Patent Application (JP-P2003-223415A; Patent document 8) discloses an information collaboration system. The information collaboration system has an information server, portable equipments and displays, respective of which are connected to a network. In order to make collaboration operations possible between different terminals, document data stored in the information server are transmitted to respective terminals after the format is converted to match the portable equipments and the displays.

FIG. 1 is a block diagram showing a configuration of a general two-way communication service distributing system. The system shown in FIG. 1 includes a communication server 200, user terminals 220, 230, 240 and a communication network 210 connecting the communication server 200 and each of the user terminals 220, 230, 240.

The communication server 200 includes a data input/output unit 201, a connection management unit 202 and a data generating unit 203. When each terminal logs-in, the data input/output unit 201 inputs information about environment for usage (user environment) of the each terminal. The connection management unit 202 manages connection statuses of respective terminals. The data generating unit 203 generates data in a format corresponding to the user environment and the connection status of each terminal, and transmits the generated data to the terminal.

The data input/output unit 201 inputs information about the user environment of a user terminal, then the connection management unit 202 analyzes properties of the user terminal and begins to manage the connection status. For example, the connection management unit 202 selects one user terminal which is already connected and suitable for receiving communication data. Also, the data generating unit 203 controls the quality level of transmission data according to the properties of the selected user terminal. The data input/output unit 201 transmits the transmission data to the selected user terminal.

Let us consider a situation when a two-way communication is established between a first user and a second user. Here, the first user uses a desktop personal computer (PC) and the second user uses a mobile terminal. The mobile terminal connected to a communication network sometimes has a different operating system (OS). Also, the screen size of the mobile terminal is generally smaller than that of the desktop personal PC. The desktop PC generally has an advanced OS and larger screen size. Therefore, it is sometimes impossible in such a two-way communication to share the same screen or exchange audio/video data. That is to say, under a condition that a variety of user terminals including mobile terminals are connected to a communication network, it is difficult to establish practical communications between the user terminals having different performances. Here, performances being different means that operation environments such as screen sizes and operation systems of the user terminals are different from each other.

Also, in such a two-way communication between terminals having different performances, contents of a communication operation can not be appropriately transmitted to a terminal which does not support the display of the communication operation. In order to solve such a problem, for example, quality level of the contents is changed by modifying resolution of image and bit rate of audio data in conventional systems. Also, a still picture is displayed instead of a moving picture, or data format is changed by converting the contents of image to text data. However, such methods can not be applied to communication operations peculiar to the two-way communication in which the conversion of the quality level is impossible. The communication operations peculiar to the two-way communication include, for example, an annotation function (a function for indicating a point of regard by displaying an arrow pointer or a dialog balloon on a screen) and a writing function (a whiteboard function for drawing on a screen and a substitute function for inputting on behalf of the other user). When there is a communication operation which can not be used because the level conversion is impossible, it is preferable to achieve the two-way communication by using another communication function which substitutes a communication function transmitting the meanings of the communication operation (communication contents).

Also, it is preferable to achieve in a user terminal a screen operation interface which is a combination of usable communication functions.

According to the systems disclosed in the above-mentioned patent documents 1 and 2, when carrying out a two-way communication by using a communication function, a user terminal is controlled to be connected to only user terminals having the same user environment. Therefore, it is impossible to keep a connection between user terminals having different user environments and to continue the two-way communication between the user terminals by using the communication function.

According to the equipment disclosed in the above-mentioned patent documents 3, 6 and 7, the quality level of contents is converted for carrying out a two-way communication by using a communication function. However, such a method of converting the quality level can not be applied to the communication functions such as the annotation function and the writing function which are peculiar to the two-way communication.

According to the method disclosed in the above-mentioned patent document 4, the data format is changed, for example, by converting color information of an image to text information. However, contents of an operation by a user can not be changed. For example, information about positions of an arrow pointer can not be changed for a user terminal which does not support the annotation function.

According to the method disclosed in the above-mentioned patent document 5, a size of a screen displaying texts and images is adjusted according to user terminals. However, it is not possible to automatically configure an operation screen in which usable communication functions are synthesized.

According to the method disclosed in the above-mentioned patent document 8, an object displayed on a large screen can be indicated by using a mobile terminal, but a communication operation can not be transmitted bi-directionally. Also, the function which can be used in the system is specialized for an indication operation, and the other versatile operations are not supported.

### SUMMARY OF THE INVENTION

It is therefore an object of the present invention to achieve a communication service providing system, a communication server, a communication service providing method and a communication service providing program which can establish a two-way communication between user terminals having different performances by utilizing a substitute function when there is an unavailable communication function due to limitation in operation environments of the user terminals.

In an aspect of the present invention, a system for providing communication service includes a communication server, a plurality of user terminals connected to the communication server via a communication network, a connection management unit, a service control unit and a data generating unit. The connection management unit detects information about an operation environment of each of the plurality of user terminals. The service control unit analyzes a meaning of a communication operation received from one of the plurality of user terminals, and determines an applicable data format used for transmitting the communication operation to another of the plurality of user terminals according to the operation environment of the other user terminal. The data generating unit generates transmission data to be provided for the other user terminal based on the applicable data format determined by the service control unit.

Since the system has the service control unit, it becomes possible to prepare a plurality of means of expression (means associated with respective of the communication functions) for one communication operation. Thus, it is possible to provide a communication service which is appropriate for an arbitrary user environment.

The connection management unit includes an environment detecting unit and a connecting terminal management unit. The environment detecting unit detects the operation environment of each of the plurality of user terminals. The connecting terminal management unit manages a connection status of each user terminal with the communication network.

The service control unit includes a status analyzing unit and a function selecting-synthesizing unit. The status analyzing unit analyzes the meaning of the communication operation received from the one user terminal. The function selecting-synthesizing unit selects a communication function used for expressing the meaning of the communication operation in the other user terminal according to the operation environment of the other user terminal.

The data generating unit includes a communication function data generating unit which generates the transmission data based on the communication function selected by the function selecting-synthesizing unit.

The plurality of user terminals include user terminals having different performances. In this case, the function selecting-synthesizing unit selects a plurality of the communication functions which are usable in the other user terminal according to the operation environment of the other user terminal, and synthesizes the plurality of communication functions. The communication function data generating unit generates a screen data for displaying a combination of the plurality of communication functions.

The system further includes a terminal information setting interface used for setting terminal information indicating the operation environment of each of the plurality of user terminals, a conversion information setting interface used for setting the applicable data format, a service information setting interface used for setting association between the applicable data form at and the communication function, and a screen layout setting interface used for setting a screen layout in each user terminal.

The system further includes a terminal information managing interface used for managing the terminal in formation, a conversion information managing interface used for managing the applicable data format, a service information managing interface used for managing the association between the applicable data format and the communication function, and a screen layout managing interface used for managing the screen layout.

The conversion information managing interface is also used for registering an attribute of the communication operation.

The service information managing interface sets priority for the communication function according to the operation environment.

The screen layout setting interface sets the screen layout according to the combination of the plurality of communication functions.

In the system mentioned above, the communication function data generating unit can be provided in each of the plurality of user terminals.

In the system mentioned above, the status analyzing unit and the function selecting-synthesizing unit can be provided in each of the plurality of user terminals.

In another aspect of the present invention, a method of providing communication service in a communication service providing system is provided. Here, the communication service providing system includes a communication server and a plurality of user terminals connected to the communication server via a communication network. The method according to the present invention includes the following steps: (A) the communication server stores terminal information indicative of operation environments of respective of the plurality of user terminals in a memory unit; (B) when one of the plurality of user terminals logs-in the communication server, the communication server retrieves an operation environment of the one user terminal from the terminal information stored in the memory unit; and (C) the communication server selects a communication function used for expressing a communication operation executed by the one user terminal in another of the plurality of user terminals according to another operation environment of the other user terminal.

In the (C) selecting step, the communication server converts the communication operation executed by the one user terminal into a data format associated with the communication function supported by the other user terminal.

The (C) selecting step includes (C1) abstracting meanings of respective of a plurality of communication operations by using at least one attribute; (C2) determining an attribute associated with the communication operation executed by the one user terminal; and (C3) determining based on the attribute a data format associated with the communication function which is supported by the other user terminal and used for expressing the communication operation in the other user terminal.

The method can further includes a step in which the communication server stores a plurality of data formats associated with each of a plurality of communication functions in the memory unit. Accordingly, in the (C3) determining step, the data format used for expressing the communication operation is selected from the plurality of data formats.

One data format which is most appropriate for the other operation environment of the other user terminal can be specified as the data format.

One data format which is most appropriate for a usage status of the other user terminal can be specified as the data format.

In the method, the plurality of user terminals receiving the same communication service is managed as one community group.

In the method, a layout of an operation screen of the other user terminal is automatically generated according to a combination of communication functions supported by the other user terminal.

The layout can be generated according to a combination of communication functions selected by a user.

If terminal information of the one user terminal is not stored in the memory unit when the one user terminal logs-in the communication server, the communication server can require the one user terminal to transmit terminal information of the one user terminal at a time of next data transmission, and then stores the received terminal information in the memory unit.

The communication server can have a translation program. In this case, the one user terminal transmits the communication operation in a dedicated language. The communication server interprets a meaning of the communication operation by executing the translation program.

If the communication server receives a plurality of communication operations successively from the one user terminal, the communication server selects one data format synthesizing the plurality of communication operations as the data format.

In the method, the communication server can determine a data type of information about the communication operation and select the data format according to the data type determined.

If a plurality of data formats are selected, the data format can be specified from the plurality of data formats according to a predetermined priority.

In still another aspect of the present invention, a communication server, which is connected to a plurality of user terminals via a communication network and provides a communication service for each of the plurality of user terminals, includes a connection management unit, a service control unit and a data generating unit. The connection management unit detects information about an operation environment of each of the plurality of user terminals. The service control unit analyzes a meaning of a communication operation received from one of the plurality of user terminals, and determines an applicable data format used for transmitting the communication operation to another of the plurality of user terminals according to the operation environment of the other user terminal. The data generating unit generates transmission data to be provided for the other user terminal based on the applicable data format determined by the service control unit.

In this communication server, the connection management unit includes an environment detecting unit and a connecting terminal management unit. The environment detecting unit detects the operation environment of each of the plurality of user terminals. The connecting terminal management unit manages a connection status of each user terminal with the communication network.

The service control unit includes a status analyzing unit and a function selecting-synthesizing unit. The status analyzing unit analyzes the meaning of the communication operation received from the one user terminal. The function selecting-synthesizing unit selects a communication function used for expressing the meaning of the communication operation in the other user terminal according to the operation environment of the other user terminal.

The data generating unit includes a communication function data generating unit which generates the transmission data based on the communication function selected by the function selecting-synthesizing unit.

The function selecting-synthesizing unit selects a plurality of the communication functions which are usable in the other user terminal according to the operation environment of the other user terminal, and synthesizes the plurality of communication functions. The communication function data generating unit generates a screen data for displaying a combination of the plurality of communication functions.

In still another aspect of the present invention, a computer program product implemented in a communication server connected to a plurality of user terminals via a communication network is provided. The computer program product includes: computer readable code configured to cause the communication server to detect information about an operation environment of each of the plurality of user terminals; computer readable code configured to cause the communication server to analyze a meaning of a communication operation received from one of the plurality of user terminals and determine an applicable data format used for transmitting the communication operation to another of the plurality of user terminals according to the operation environment of the other user terminal; and computer readable code configured to cause the communication server to generate transmission data to be provided for the other user terminal based on the applicable data format.

In still another aspect of the present invention, a computer program product includes: computer readable code configured to cause the communication server to detect an operation environment of each of the plurality of user terminals; computer readable code configured to cause the communication server to manage a connection status of each user terminal with the communication network; computer readable code configured to cause the communication server to analyze a meaning of a communication operation transmitted from each user terminal; computer readable code configured to cause the communication server to select a communication function used for expressing the meaning of the communication operation according to the operation environment of each user terminal; and computer readable code configured to generate transmission data based on the selected communication function.

According to the present invention, it becomes possible to prepare a plurality of means of expression for one communication operation. Therefore, it is possible to establish a two-way communication by applying an alternative, even if there is a disabled communication function due to limitation of an operation environment in a user terminal among a plurality of user terminals having different performances.

### BRIEF DESCRIPTION OF THE DRAWINGS

FIG. 1 is a block diagram showing a configuration of a general two-way communication service distributing system;

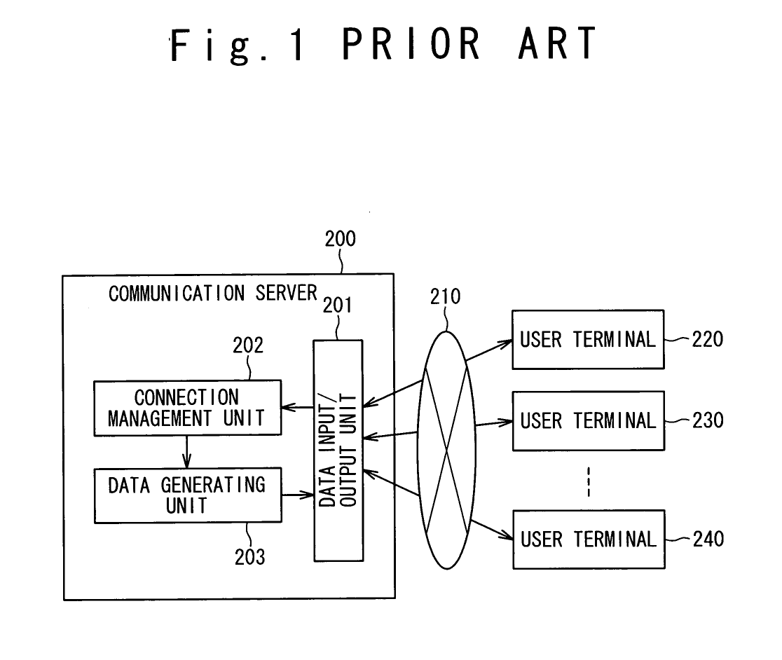

FIG. 2 is a schematic diagram showing an overview of the present invention;

FIG. 3 is a block diagram showing a first embodiment of a communication service providing system according to the present invention;

FIG. 4 is a flow chart showing an operation of a communication server;

FIG. 5 is a flow chart showing an operation of a user terminal;

FIG. 6 is a block diagram showing a second embodiment of a communication service providing system according to the present invention;

FIG. 7 is a block diagram showing a third embodiment of a communication service providing system according to the present invention;

FIG. 8A is an explanatory diagram showing an example of an operation screen displayed on the user terminal;

FIG. 8B is an explanatory diagram showing an example of an operation screen displayed on the user terminal;

FIG. 9A is an explanatory diagram showing an example of a screen layout setting screen;

FIG. 9B is an explanatory diagram showing an example of a conversion information setting screen;

FIG. 10A is an explanatory diagram showing another example of an operation screen displayed on the user terminal;

FIG. 10B is an explanatory diagram showing another example of an operation screen displayed on the user terminal;

FIG. 11A is an explanatory diagram showing still another example of an operation screen displayed on the user terminal; and

FIG. 11B is an explanatory diagram showing another example of an operation screen displayed on the user terminal.

### DESCRIPTION OF THE PREFERRED EMBODIMENTS

Embodiments of the present invention will be described below with reference to the attached drawings.

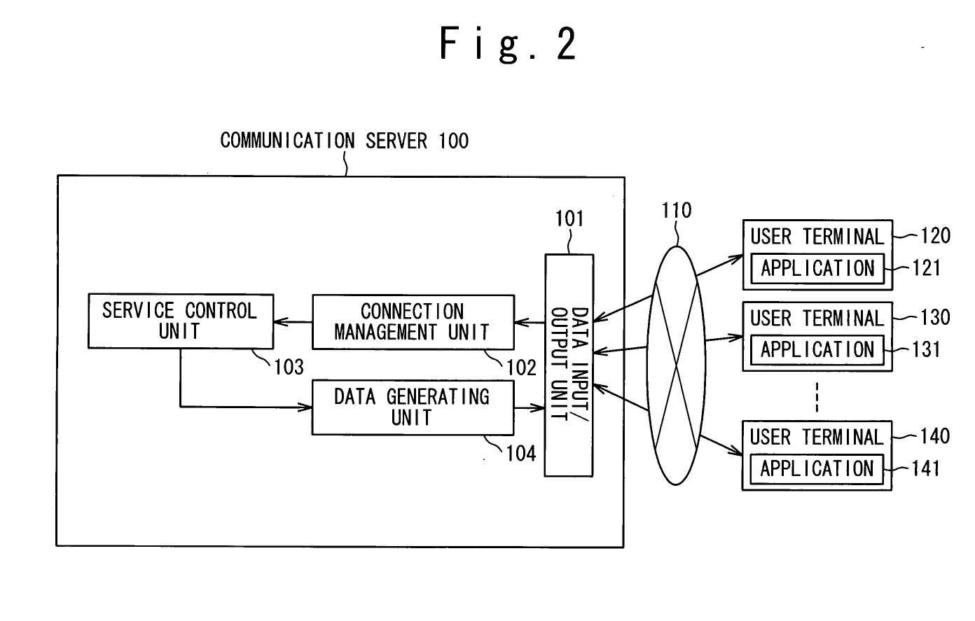

FIG. 2 is a schematic diagram showing an overview of the present invention. A communication service providing system according to the present invention includes a communication server 100 providing a two-way communication service, user terminals 120, 130, 140 which have different performances and a communication network 110 connecting the communication server 100 and the user terminal 120, 130, 140. It should be noted that the user terminals 120, 130, 140 in the system shown in FIG. 2 may include user terminals having the same performance.

The communication server 100 includes a data input/output unit 101, a connection management unit 102, a service control unit 103 and a data generating unit 104. The user terminals 120, 130, 140 have application software 121, 131, 141 used for receiving the two-way communication service, respectively.

Each of the application software 121, 131, 141 of the user terminals 120, 130, 140 transmits a log-in request including information about a “user environment” of own terminal and a “communication operation” to the communication server 100. For example, the application software 121 of the user terminal 120 transmits a log-in request. The data input/output unit 101 of the communication server 100 receives the log-in request. Then, on the basis of the information in the log-in request, the connection management unit 102 detects “terminal information” indicating basic functions supported by the user terminal 120.

Also, when receiving the information about a communication operation from the user terminal 120, the service control unit 103 interprets the meaning of the communication operation by the user, and then determines a data format which is applicable for transmitting the communication operation. In a broad sense, the “communication operation” means functions for implementing communications, which includes an annotation function and a writing function. Furthermore, the “communication operation” means also an operation which is done for an input device by a user to communicate with another user when those functions are being used.

Also, the service control unit 103 selects an appropriate communication function for every user terminal (130, 140) on the basis of the terminal information of the other user terminals 130, 140 detected by the connection management unit 102. The data generating unit 104 generates transmission data according to the operation environments of the user terminals 130, 140. The transmission data are transmitted to the user terminals 130, 140 by the data input/output unit 101. In the user terminals 130, 140, still pictures are displayed or audio/video data are played according to the transmission data. The display/play are carried out by usable communication functions implemented by the application software 131, 141.

Also, in accordance with a combination of the communication functions selected by the service control unit 103, the data generating unit 104 automatically generates an operation screen optimized for communication service, namely an operation screen which is considered to be most easy-to-use for users.

In the communication server 100, the functions of the connection management unit 102, the service control unit 103 and the data generating unit 104 are implemented by software. That is to say, the communication server 100 has a communication service providing program for carrying out the following processes: a process of detecting information about operation environments of the respective user terminals; a process of analyzing the meanings of communication operations received from the respective user terminals and then determining a data format which is applicable for expressing the communication operation according to the operation environments of the other user terminals; and a process of generating transmission data in the determined data format to be provided for the other users.

### First Embodiment

Embodiments of the present invention will be described in detail hereinafter.

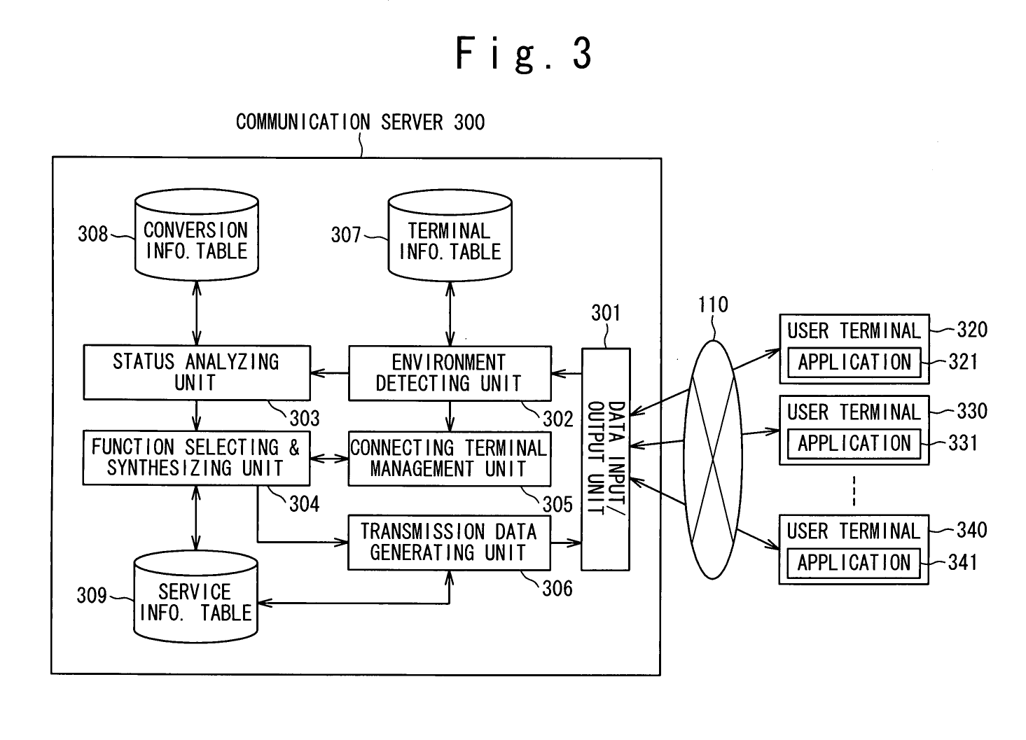

FIG. 3 is a block diagram showing a first embodiment of a communication service providing system according to the present invention. The communication service providing system according to the first embodiment includes a communication server 300 providing a two-way communication service, user terminals 320, 330, 340 which have different performances and a communication network 110 connecting the communication server 300 and the user terminal 320, 330, 340. It should be noted that the user terminals 320, 330, 340 in the system shown in FIG. 3 may include user terminals having the same performance.

The communication server 300 has a data input/output unit 301, an environment detecting unit 302, a status analyzing unit 303, a function selecting-synthesizing unit 304, a connecting terminal management unit 305 and a transmission data generating unit 306. In addition, the communication server 300 has a terminal information table 307 which the environment detecting unit 302 can access, a conversion information table 308 which the status analyzing unit 303 can access and a service information table 309 which the function selecting-synthesizing unit 304 and the transmission data generating unit 306 can access. All the tables are stored in a memory unit such as a hard disk drive. The user terminals 320, 330, 340 have application software 321, 331, 341 for implementing two-way communication services, respectively. The two-way communication services which the communication server 300 provides are implemented by a server-side application program, or a dedicated device, or a combination of them. The application software 321, 331, 341 are realized by a Windows (trademark) application program, or a Java (trademark) applet, or a Web application program, or a combination of them. The functions of the application software 321, 331, 341 may be realized by dedicated devices.

The data input/output unit 301 receives data from respective of the user terminals 320, 330, 340 and outputs the received data to the environment detecting unit 302. Also, the data input/output unit 301 receives data from the transmission data generating unit 306 and outputs the received data to respective of the user terminal 320, 330, 340.

When a user terminal logs-in the communication server 300, the environment detecting unit 302 receives data including information about a user environment and a communication operation from the data input/output unit 301. After the user terminal logs-in, the environment detecting unit 302 receives data including information about a communication operation. The information about a user environment includes an ID of the logged-in user terminal and a connection status of the network. In the two-way communication after the log-in operation, the information about the communication operation includes an identifier of a communication operation such as a click operation on a screen and a talking operation by using a microphone, a position information indicative of a position of the operation on the screen, and encoded audio data.

Detailed terminal information are registered in the terminal information table 307 beforehand. Based on the ID of the user terminal, the environment detecting unit 302 retrieves the detailed terminal information from the terminal information table 307 and acquires the detailed terminal information associated with the ID of the user terminal. The detailed terminal information include a terminal environment (operational environment) such as basic functions which the user terminal supports, an external interface and so on. The information about the basic functions include an OS (Operating System) installed in the user terminal, standard tools, a screen size, a memory capacity, a capacity of a hard disk drive and so on. The information about the external interface include information about a sound device, a microphone device, a pointing device such as a mouse and so on. The communication server 300 has a terminal information setting interface. It is possible by using the terminal information setting interface to input the detailed terminal information in advance and to register the detailed terminal information on the terminal information table 307. The terminal information setting interface is implemented, for example, by an input device such as a keyboard and software for processing the registration of the information inputted by the input device on the terminal information table 307. Also, the environment detecting unit 302 outputs to the connecting terminal management unit 305 connecting terminal information which includes a terminal information of a logged-in user terminal and information about connection status of the logged-in user terminal to the network. More over, the environment detecting unit 302 outputs information about the communication operation to the status analyzing unit 303. Here, the information about the connection status includes a type, a bandwidth, a traffic and so on of the line through which the logged-in terminal is connecting. Also, the terminal information setting interface is used for changing the terminal information of the user terminals registered on the terminal information table 307. That is to say, the terminal information setting interface is an interface for managing the terminal information of the user terminals.

The status analyzing unit 303 receives the information about the communication operation from the environment detecting unit 302 and analyzes the meaning of the communication operation. The meaning of the communication operation is a content of the communication operation and is referred to as a “communication content” hereinafter. Registered on the conversion information table 308 are applicable data formats (conversion formats) which are associated with the communication contents. Based on an identifier of a communication operation, the status analyzing unit 303 retrieves a list of data formats applicable to a communication content from the conversion information table 308.

The data format includes a video format, a moving picture format, a successive images format, a still picture format, an audio format, a text format, a position information format and so on. The communication server 300 has a data setting interface. It is possible by using the data setting interface to register on the conversion information table 308 beforehand the data formats with which respective of the communication contents can be converted. That is to say, the data setting interface provides a conversion information setting interface used for setting the data formats with which a communication operation can be converted. For example, the meaning of a communication operation is abstracted by using one attribute or a plurality of attributes. That is to say, each communication operation is made related to one attribute or a plurality of attributes. By listing up data formats which can express the one attribute or the plurality of attributes as many as possible, one applicable data format or a plurality of applicable data formats with which the communication operation can be converted are defined. Therefore, information about attributes are also registered on the conversion information table 308 by using the data setting interface. The data setting interface is implemented, for example, by an input device such as a keyboard and software for processing the registration of the information inputted by the input device on the conversion information table 308. The attribute is an index which indicates types of a communication operation. The operations indicated by the attribute include, for example, an operation associated with “position”, an operation associated with “action”, an operation associated with “local (partial) area” (a local operation on a screen), an operation associated with “whole area” (an operation over whole or a wide range of a screen) and the like.

The data setting interface is also used by an administrator of the communication server 300 to change the data formats which are registered on the conversion information table 308 and are associated with the communication contents. That is to say, the data setting interface is an interface for managing the data formats registered on the conversion information table 308.

The status analyzing unit 303 outputs a content of a communication operation and a list of data formats applicable to the communication operation to the function selecting-synthesizing unit 304. Also, when the communication server 300 provides an operation screen for a user terminal, namely, when the user terminal has logged-in the communication server 300, the status analyzing unit 303 outputs information indicating generation of the operation screen to the function selecting-synthesizing unit 304.

The function selecting-synthesizing unit 304 inputs data from the status analyzing unit 303. Then, the function selecting-synthesizing unit 304 requests the connecting terminal management unit 305 to provide a connecting terminal information about the user terminal which has transmitted the information about the communication operation. The connecting terminal information includes a terminal information and a connection status of the user terminal. The function selecting-synthesizing unit 304 compares the list of data formats received from the status analyzing unit 303 and the connecting terminal information received from the connecting terminal management unit 305. Based on result of the comparison, the function selecting-synthesizing unit 304 determines a data format which the user terminal can represent (display or play) by the usable functions. The function selecting-synthesizing unit 304 refers to the service information table 309, and selects a communication function (a data sharing function, a video data exchange function, an audio data exchange function and the like) which uses the determined data format (video, moving picture, successive images, still picture, audio, text, position information and the like). If there are a plurality of data formats which are suitable for the user terminal, the function selecting-synthesizing unit 304 selects the one optimum communication function or synthesizes a plurality of communication functions. For example, the function selecting-synthesizing unit 304 receives a usage status from the connecting terminal management unit 305. In this case, the function selecting-synthesizing unit 304 can select a communication function to be used after comprehending based on the usage status, for example, that the bandwidth of the connection line is narrow, or the network in-use is busy or the performance of the user terminal is low.

Through the data setting interface, the communication server 300 registers correspondence of the communication functions to the data formats on the service in formation table 309 beforehand. That is to say, the data setting interface realized a service information setting interface used for setting the information about association between the applicable data formats and the communication functions. The operation environments of the user terminals necessary for executing the communication functions are also registered on the service information table 309 for every communication function. The necessary operation environments of the user terminals are also registered beforehand by using the data setting interface. Furthermore, templates of screen layouts when a user executes the communication functions are also registered on the service information table 309. The templates are also registered beforehand by using the data setting interface. That is to say, the data setting interface realizes a screen layout setting interface used for setting the screen layouts displayed on the user terminals. The data setting interface is implemented, for example, by an input device such as a keyboard and software for processing the registration of the information inputted by the input device on the service information table 309.

The data setting interface is also used by an administrator of the communication server 300 to change the information about the correspondence of the communication functions to the applicable data formats and the screen layouts which are registered on the service information table 309. That is to say, the data setting interface provides a service information managing interface for managing the correspondence of the communication functions to the applicable data formats and a screen layout managing interface for managing the screen layouts.

The function selecting-synthesizing unit 304 outputs the information about the selected communication function to the transmission data generating unit 306. When the function selecting-synthesizing unit 304 receives the information indicating the generation of an operation screen from the status analyzing unit 303, the function selecting-synthesizing unit 304 selects all the communication functions that can be used in the user terminal and outputs the information about the communication functions to the transmission data generating unit 306.

When receiving the connecting terminal information of logged-in user terminals from the environment detecting unit 302, the connecting terminal management unit 305 manages the logged-in user terminals for every community group. The community group is defined as a group including a plurality of user terminals for which the communication server 300 provides the same two-way communication simultaneously. When a user terminal belonging to a community group logs-out from the communication server 300, the user terminal is eliminated from the community group. Also, when all user terminals belonging to a community group log-out from the communication server 300, the community group itself is eliminated.

Furthermore, when required by the function selecting-synthesizing unit 304 to provide a connecting terminal information of a logged-in user terminal, the connecting terminal management unit 305 outputs to the function selecting-synthesizing unit 304 the connecting terminal information in a unit of a user terminal or a community group to which the communication content is transmitted.

The transmission data generating unit 306 as a “communication function data generating unit” selects a data format from the data formats registered on the service information table 309, based on the information about the communication functions received from the function selecting-synthesizing unit 304. Then, the transmission data generating unit 306 generates transmission data according to the selected data format.

Also, when an operation screen provided for a user terminal is necessary, the transmission data generating unit 306 receives a template of the screen layout from the service information table 309 and generates a screen layout data which is appropriate for the user terminal. The screen layout data includes information about screens in which the communication functions are synthesized. That is to say, the screen layouts based on the combination of the usable communication functions are set by the screen layout setting interface. The transmission data generating unit 306 generates the screen layout data according to the performance of the user terminal.

Each of the application software 321, 331, 341 of the user terminals transmits to the communication server 300 information about the communication operation including the user environment of the user terminal, the log-in request and the log-out request. Then, based on the data received from the data input/output unit 301, each of the application software 321, 331, 341 displays a screen or plays audio/video data by using the communication functions.

The data input/output unit 301 corresponds to the data input/output unit 101 shown in FIG. 2. The environment detecting unit 302 and the connecting terminal management unit 305 correspond to the connection management unit 102 shown in FIG. 2. The status analyzing unit 303 and the function selecting-synthesizing unit 304 correspond to the service control unit 103 shown in FIG. 2. The transmission data generating unit 306 corresponds to the data generating unit 104 shown in FIG. 2. The user terminals 320, 330, 340 correspond to the user terminals 120, 130, 140 shown in FIG. 2.

Also, the communication network 110 can be any of the Internet, an intranet, a wireless communication network, a cable communication network and so on.

Also, in the communication server 300, the functions of the environment detecting unit 302, the status analyzing unit 303, the function selecting-synthesizing unit 304, the connecting terminal management unit 305 and the transmission data generating unit 306 are implemented by software. That is to say, the communication server 300 has a communication service providing program for carrying out the following processes: a process of detecting an operation environment of a user terminal a process of managing a connection status of the user terminal to a communication network; a process of analyzing a meaning of a communication operation transmitted from the user terminal; a process of selecting a communication function used for expressing the meaning of the communication operation according to the operation environment of the user terminal; and a process of generating data in the selected data format.

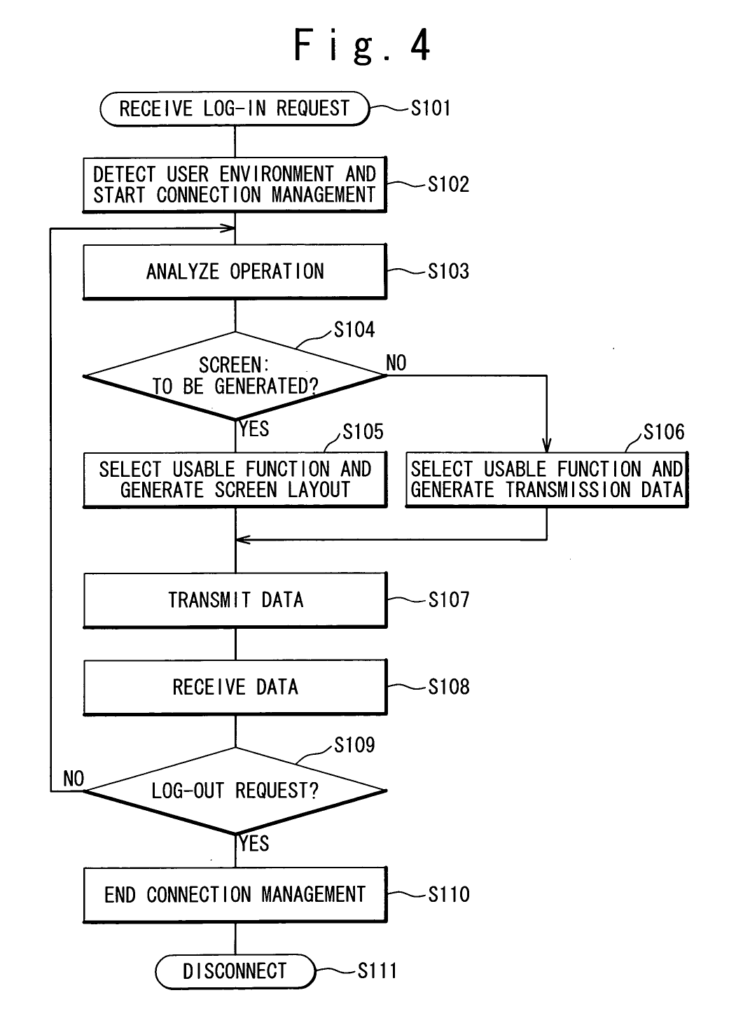

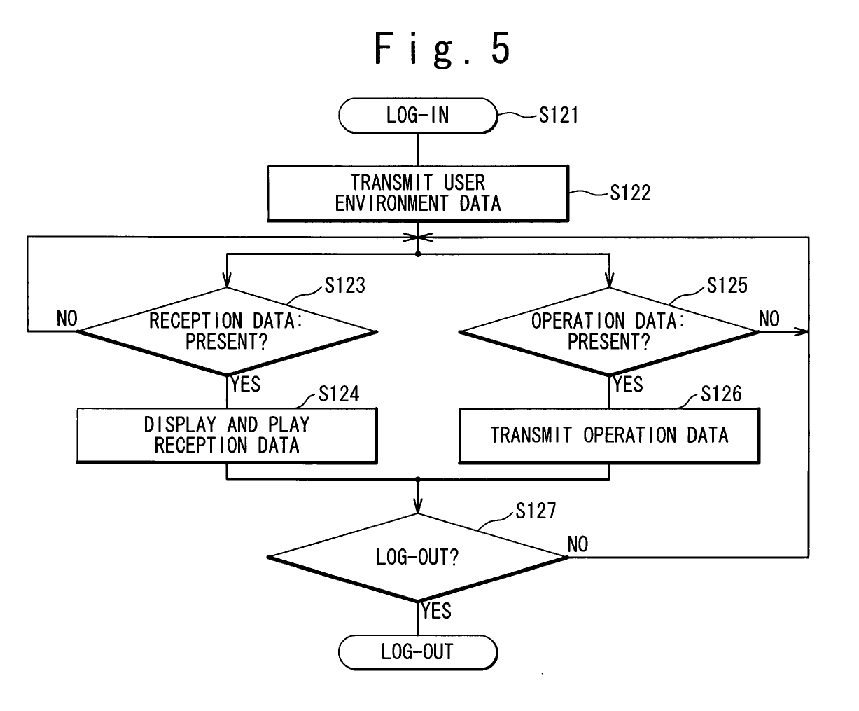

Next, operations of the system according to the first embodiment will be described with reference to flow charts shown in FIG. 4 and FIG. 5. FIG. 4 is a flow chart showing operations of the communication server 300. Here, a case where the user terminal 320 logs-in the communication server 300 is described as an example.

First, the data input/output unit 301 receives a log-in request from the user terminal 320 via the communication network 110 (Step S101), and then outputs information about a user environment to the environment detecting unit 302. The information about the user environment is transmitted from the user terminal 320 together with the log-in request. Based on a terminal ID included in the information about the user environment, the environment detecting unit 302 retrieves a detailed terminal information from the terminal information table 307. Thus, the environment detecting unit 302 acquires the detailed terminal information including information about basic functions supported by the user terminal 320 and information about external interfaces. Next, the connecting terminal management unit 305 registers a connecting terminal information of the logged-in user terminal 320 in the new entry. The connecting terminal information include terminal information and network connection status information of the user terminal. Thus, the connecting terminal management unit 305 starts monitoring the usage of the two-way communication service (Step S102). The network connection status information is transmitted by the user terminal 320 together with the log-in request.

If the user terminal 320 specifies another user terminal which has already connected with the communication server 300 and the user terminal 320 starts communicating with the other user terminal, a community group is formed. For example, let us consider a case where the user terminal 330 has already logged-in and after that the user terminal 320 logs-in the communication server 300. In order to establish a two-way communication between the user terminals 320 and 330, a community group including the user terminals 320 and 330 is newly generated.

Next, based on the information about the communication operation received from the data input/output unit 301, the status analyzing unit 303 determines whether the communication operation is a log-in operation or a user operation concerning a communication service (namely, an operation after the log-in). If the communication operations a log-in operation, it is recognized to be necessary to provide an operation screen of the communication service for the user terminal 320 (Step S103, S104).

If the provision of the operation screen is necessary, the function selecting-synthesizing unit 304 receives the terminal information of the user terminal 320 from the connecting terminal management unit 305. Based on the information about the basic functions supported by the user terminal 320 and the information about the external interfaces included in the terminal information, the function selecting-synthesizing unit 304 extracts all the usable communication functions in the user terminal 320 from the service information table 309. The operation environment of the user terminal necessary for using a communication function is registered on the service information table 309 for every communication function. Also, the function selecting-synthesizing unit 304 searches the service information table 309 for a template of a screen layout which is optimum for displaying the synthesized communication functions (Step S105).

The transmission data generating unit 306 generates screen data of the operation screen of the user terminal 320 on the basis of the template of the screen layout selected by the function selecting-synthesizing unit 304. Then, the transmission data generating unit 306 outputs the screen data together with initial data of communication functions to the data input/output unit 301. The data input/output unit 301 transmits the data received from the transmission data generating unit 306 to the user terminal 320 via the communication network 110 (Step S107). Due to the processes mentioned above, a connection between the communication server 300 and the user terminal 320 is established and the two-way communication service becomes available.

Thus, the connection between the communication server 300 and the user terminal 320 has been established. Then, the user terminal 320 transmits information about a communication operation to the communication server 300. In this case, the status analyzing unit 303 checks whether the information about the communication operation is a log-out request or not (Step S108, S109).

If the information is a log-out request, the connecting terminal management unit 305 eliminates the connecting terminal information of the managed user terminal 320. If the community group to which the user terminal 320 has belonged includes no more user terminal, the connecting terminal management unit 305 eliminates also the community group (Step S110). Due to the processes mentioned above, the user terminal 320 is disconnected from the communication server 300 (Step S111).

If the status analyzing unit 303 judges in the Step S103 that the communication server 300 has received information about a communication operation, the status analyzing unit 303 extracts an identifier of the communication operation from the information about the communication operation. The application software 321 in the user terminal 320 set the identifier for every communication operation. For example, when a communication operation is carried out in which a point on the screen is indicated by a pointing device such as a mouse connected to the user terminal 320, a communication is achieved by specifying the point on another screen of another user's terminal or by transmitting a content of the communication operation that the point has been indicated. The meanings of the respective of the communication operations are abstracted by some attributes. In the conversion information table 308, data formats each of which can express one attribute or a plurality of attributes are listed. The data formats is defined as applicable data formats. That is to say, the analysis of the meaning of a communication operation can be achieved by determining to which attribute the communication operation specified by the identifier belongs.

Based on the identifier of the communication operation, the status analyzing unit 303 searches the conversion information table 308 for applicable data formats (conversion formats) with which the communication operation can be converted, and acquires a list of the applicable data formats.

Next, the function selecting-synthesizing unit 304 obtains from the connecting terminal management unit 302 information of the community group including the user terminal 320 which has executed the communication operation. Here, the user terminals 330, 340 also belong to the community group. The function selecting-synthesizing unit 304 selects one or more data formats from the data formats received from the status analyzing unit 303 for every user terminal (330, 340). The selected data format is a format which can be expressed (displayed or played) in the user terminals 330, 340 by using the usable functions. If there are a plurality of data formats which can be expressed by the user terminal (330, 340), the function selecting-synthesizing unit 304 may select the optimum data format according to the connecting terminal information of each of the user terminals 330, 340.

The connecting terminal management unit 305 can periodically sample information about the connection status and the operation screen currently displayed from the user terminals 320, 330, 340 to manage the connecting terminal information of respective of the user terminals 320, 330, 340. The transmission data generating unit 306 converts the communication operation data to transmission data which has the data format selected by the function selecting-synthesizing unit 304. Thus, the transmission data is generated (Step S106). The data input/output unit 301 transmits the transmission data received from the transmission data generating unit 306 to respective of the user terminals 330, 340 via the communication network 110 (Step S107).

Next, operations of a user terminal (the user terminal 320) will be described in detail. FIG. 5 is a flow chart showing the operations of a user terminal.

When the user terminal 320 tries to log-in to the communication server 300 by using the application software 321, the application software 321 detects information about a user environment of the user terminal 320 and transmits the information together with a log-in request (Steps S121, S122). The information about the user environment includes information about a terminal ID and a network connection status.

The user terminal 320 receives reception data from the communication server 300. If there are reception data, the application software 321 display/play the video/image/audio data based on the reception data (Steps S123, S124).

Also, when a user utilizes the two-way communication service provided by the communication server 300, the application software 321 detects a user operation and transmits information of the user operation (communication operation) to the communication server 300 (Steps S125, S126).

Also, when the application software 321 carries out a log-out operation in response to a user operation, the user terminal 320 is automatically disconnected from the communication server 300 and the two-way communication service is terminated (Steps S127, S128). It should be noted that the two-way communication service continues unless the log-out operation is executed.

According to the present embodiment, as described above, the status analyzing unit 303 interprets the contents of the communication operations and selects a plurality of applicable data formats (video, moving picture, successive images, still picture, audio, text and so on). Moreover, the function selecting-synthesizing unit 304 selects the optimum communication function (the data sharing function, the video data exchange function, the audio data exchange function and the like) for each of the user terminals 320, 330, 340. It is therefore possible to provide a two-way communication service appropriate for a user environment. Furthermore, the function selecting-synthesizing unit 304 is configured to automatically generate a layout of an operation screen according to the usable service contents. It is therefore possible to provide useful interfaces for users without preparing operation screens for every user terminal (320, 330, 340) beforehand.

### Second Embodiment

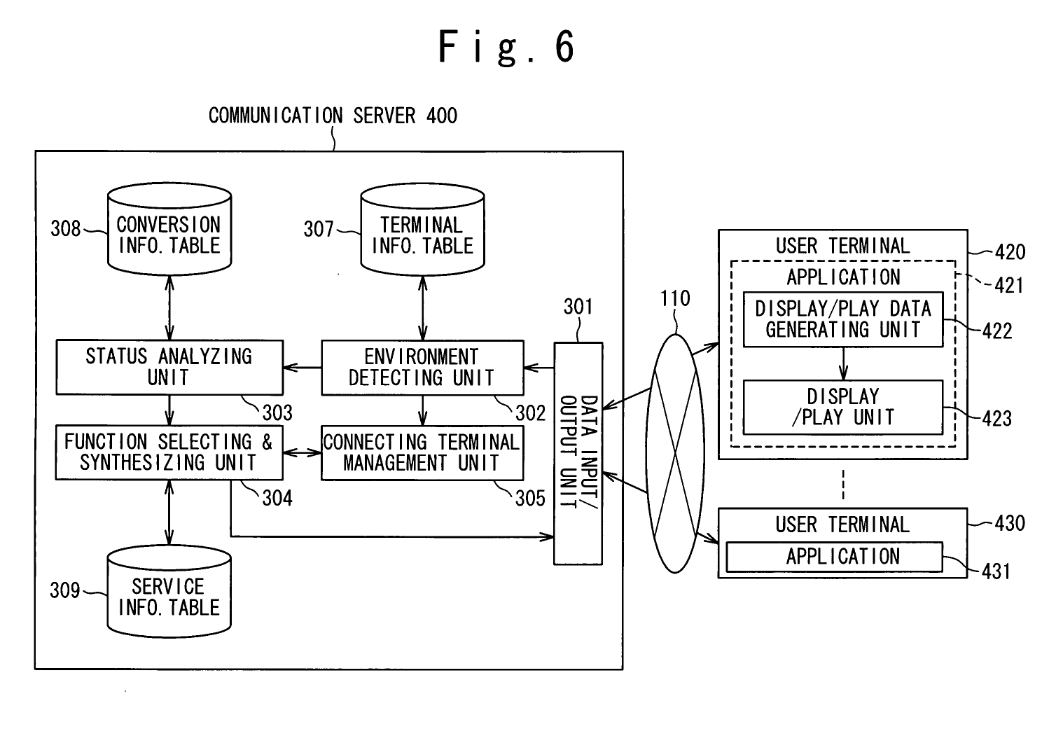

FIG. 6 is a block diagram showing a second embodiment of a communication service providing system according to the present invention. According to the present embodiment, as shown in FIG. 6, functions of the transmission data generating unit 306 in the first embodiment are implemented in the user terminal side. That is to say, the application software 421 of a user terminal 420 has a display/play data generating unit 422 and a display/play unit 423 in addition to the functions implemented by the application software of the user terminal in the first embodiment. The display/play data generating unit 422 converts the communication operation data to generate conversion data. The display/play unit 423 displays and plays based on the generated conversion data. Application software 431 in another user terminal 430 also includes a display/play data generating unit and a display/play unit. It should be noted that the functions of the display/play unit are included also in the application software of the user terminal according to the first embodiment.

In a communication server 400, a function select ing-synthesizing unit 304 operates in a similar way to the first embodiment and selects communication function s. According to the present embodiment, however, the function selecting-synthesizing unit 304 outputs the data of the selected communication functions to the data input/output unit 301. The data input/output unit 301 transmits the data of the selected communication functions to the user terminal 420 through the communication network 110.

In the first embodiment, the transmission data generating unit 306 selects a data format from the service information table 309 based on the information of the communication functions received from the function selecting-synthesizing unit 304, and generates the transmission data associated with the selected data format.

In the present embodiment, the display/play data generating unit 422 in the user terminal 420 selects a data format based on the data of the communication functions, and converts the data of the communication functions into the conversion data in the selected data form at. Therefore, the display/play data generating unit 422 has a table on which data formats associated with the user environment of the user terminal 420 are registered.

Based on the conversion data received from the display/play data generating unit 422, the display/play unit 423 displays images or plays video/audio data. The other configuration and operations are similar to those in the first embodiment.

According to the present embodiment, the transmission data generating unit 306 does not exist in the communication server 400. It is therefore possible to reduce the load on the communication server 400. Moreover, the display/play data are generated in the user terminal. Therefore, even when a large amount of display/play data are to be processed, the display/play data can be displayed/played without influence of transmission delay due to the load on the communication network 110.

### Third Embodiment

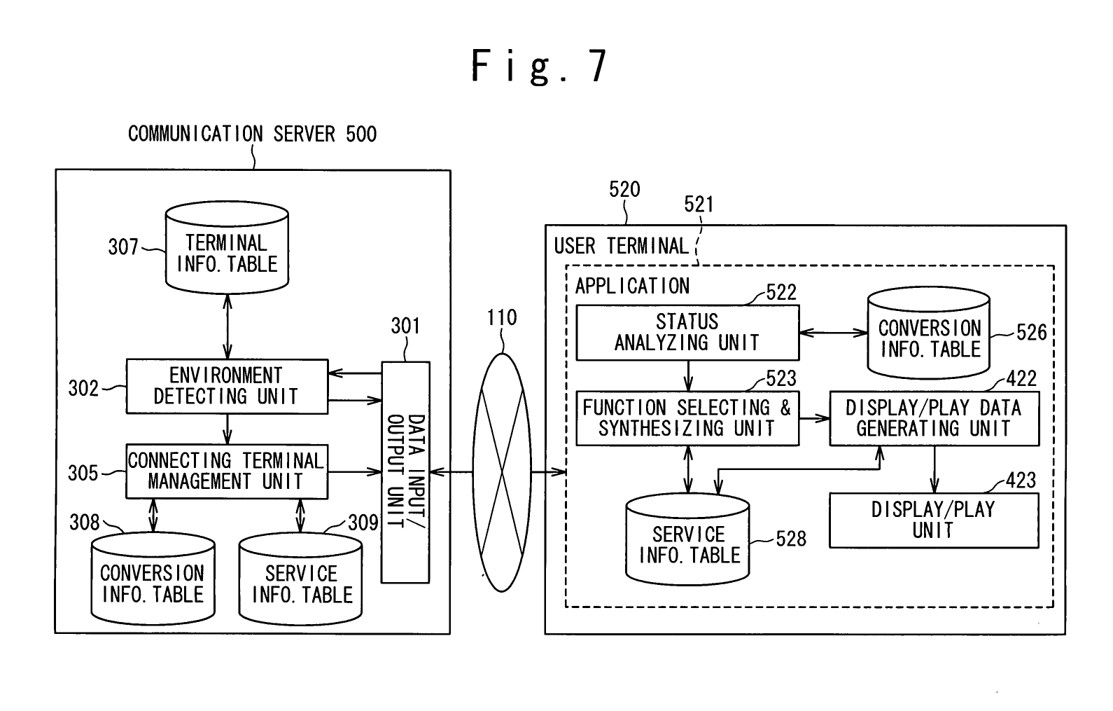

FIG. 7 is a block diagram showing a third embodiment of a communication service providing system according to the present invention. According to the present embodiment, application software 521 of a user terminal 520 also has the display/play data generating unit 422 and the display/play unit 423 as in the second embodiment Further, functions of the status analyzing unit 303 and the function selecting-synthesizing unit 304 in the communication server 300 in the first embodiment are implemented in the user terminal side. More specifically, the application software 521 of the user terminal 520 has a status analyzing unit 522 and a function selecting-synthesizing unit 523 in addition to the display/play data generating unit 422 and the display/play unit 423. The status analyzing unit 522 and the function selecting-synthesizing unit 523 operate in similar ways to the status analyzing unit 303 and the function selecting-synthesizing unit 304 included in the communication server 300 in the first embodiment, respectively.

That is to say, the status analyzing unit 522 receives information about a communication operation from the environment detecting unit 302 in a communication server 500 via the communication network 110, and analyzes the meaning of the communication operation (communication content). Data formats applicable to communication contents are registered on the conversion information table 526. Based on an identifier of the communication operation, the status analyzing unit 522 acquires a list of applicable data formats (conversion formats) associated with the communication content from the conversion information table 526. Then, the status analyzing unit 522 outputs the content of the communication operation and the list of the applicable data formats to the function selecting-synthesizing unit 523. Also, when an operation screen is to be provided for the user terminal 520, the status analyzing unit 522 outputs information of generating the operation screen as the content of the communication operation.

The function selecting-synthesizing unit 523 receives data from the status analyzing unit 522. Then, the function selecting-synthesizing unit 523 compares the list of the applicable data formats received from the status analyzing unit 522 with the terminal information of own user terminal 520, and determines a data form at which can be expressed (displayed or played) by using the usable functions. Also, the function selecting-synthesizing unit 523 selects a communication function for using the determined data format from the service information table 528. If there are a plurality of data formats which are appropriate for the user terminal 520, the function selecting-synthesizing unit 523 selects the one optimum communication function or synthesizes a plurality of communication functions.

Then, the display/play data generating unit 422 in the user terminal 520 selects a data format from the service information table 528 based on the data of the communication function, and converts the data of the communication functions into the conversion data in the selected data format. Based on the conversion data received from the display/play data generating unit 422, the display/play unit 423 displays images or plays video/audio data.

The contents of the conversion information table 308 and the service information table 309 in the communication server 500 are appropriately transmitted to the conversion information table 526 and the service information table 528 in the user terminal 520, respectively. Thus, the contents of the conversion information table 526 and the service information table 528 are the same as those of the conversion information table 308 and the service information table 309. The other configuration and operations are the similar to those in the first embodiment. It should be noted that there are a plurality of user terminals in the system as in the first and the second embodiment, although only one user terminal 520 is shown in FIG. 7.

According to the first embodiment, it is assumed that a usage status is transmitted from a user terminal to the communication server 300 and the communication function to be used is selected in the communication server 300 based on the usage status. According to the present embodiment, the optimum communication function can be selected based on a usage status without the transmission of the usage status from the user terminal 520 to the communication server 500. Therefore, it is possible to reduce an amount of data which are transmitted between the user terminal 520 and the communication server 500. Moreover, the service information table 528 is provided for every user terminal. Therefore, a user can select a desirable communication function (a data sharing function, a video data exchange function, an audio data exchange function and so on) and register the selected communication function on the service information table 528 in advance. By making an operation screen which uses the registered communication function, a user-preferred operation screen can be generated.

### Fourth Embodiment

According to the communication server 300 in the first embodiment, the detailed terminal information of each user terminal is inputted through the terminal information setting interface and is set in the terminal information table 307.

According to the present embodiment, if a detailed terminal information of a user terminal is not registered yet on the terminal information table 307 when the user terminal logs-in, the communication server 300 requires the user terminal to transmit the detailed terminal information. In this case, the user terminal transmits the detailed terminal information to the communication server 300 at the time of the next transmission after the transmission of the log-in request. Then, in the communication server 300, the environment detecting unit 302 stores the detailed terminal information received from the user terminal in the terminal information table 307.

According to such a configuration, it is possible to register the detailed terminal information on the terminal information table 307 even if the communication server 300 does not have the terminal information setting interface.

### Fifth Embodiment

According to the first embodiment, the meaning of the communication operation is abstracted by using some attributes. By listing up the data formats which can express one or more attributes as many as possible, a plurality of applicable data formats with which the communication operation can be converted are defined.

According to the present embodiment, the application software installed in the user terminal converts a communication operation into text data, and transmits the text data to the communication server 300. The text data can be described in a predetermined dedicated language. In this case, a translation program is installed in the status analyzing unit 303 in the communication server 300. The translation program installed in the status analyzing unit 303 translates the text data indicating a communication operation to the communication operation and interprets the content of the communication operation.

According to such a configuration, the status analyzing unit 303 interprets the content of the communication operation by using the translation program. Thus, it is not necessary for an administrator of the communication server 300 to set the attributes of the communication operation.

### Sixth Embodiment

In the present embodiment, when a user executes successive communication operations, the status analyzing unit 303 in the system shown in FIG. 3 determines what communication operation the user wants to express ultimately. According to such a configuration, when the user executes a plurality of communication operations successively, namely, when receiving information of the plurality of communication operations successively from the user terminal, the status analyzing unit 303 can select a data format for synthetically expressing the plurality of communication operations.

For example, let us consider an electronic conference. A user turns a page to display the second page of a document, then turns back a page to display the first page and then indicates a point on the first page of the document by using an arrow pointer, which are the successive communication operations. If the time during which the user displays the second page is shorter than a predetermined period (ex. 1 sec) due to the successive turning operations, the communication operation for displaying the second page can be omitted. Selected in this case is a data format for converting the communication operation for displaying the arrow pointer.

According to such a configuration, it is possible to reduce an amount of the communication operation data transmitted, to reduce the load on the user terminal and to prevent time-lag of the communication operation among the user terminals.

### Seventh Embodiment

In the present embodiment, the status analyzing unit 303 in the system shown in FIG. 3 has a status determining program. The status determining program determines a data type (text data, position information, encoded audio data and so on) of the information about the communication operation transmitted from the user terminal, and selects an applicable data format according to the determined data type. For example, when the data type is an audio type, the status determining program selects an audio format as the data format. In such a configuration, the status analyzing unit 303 can select an applicable data format by executing the status determining program, when receiving the communication operation data.

According to such a configuration, the status analyzing unit 303 selects the applicable data format by executing the status determining program. Therefore, it is not necessary for an administrator of the communication server 300 to set the attributes of the communication operations.

### Eighth Embodiment

The function selecting-synthesizing unit 304 of the system shown in FIG. 3 selects a plurality of applicable data formats. According to the present embodiment, the function selecting-synthesizing unit 304 further specifies a data format according to priority (for example, preference to a text display function over a audio function) which is set by an administrator of the communication server 300 beforehand. The priority is set according to the operation environment of the user terminal. For example, preference is given to the text display function over the audio function in a user terminal having a poor audio function. The priority can be registered on the conversion information table 308 of the communication server 300 in advance by using the data setting interface.

According to such a configuration, the communication server 300 can select a more appropriate communication function which the administrator desires.

### Ninth Embodiment

According to the present embodiment, when the function selecting-synthesizing unit 304 of the system shown in FIG. 3 receives the information of generating an operation screen from the status analyzing unit 303, the function selecting-synthesizing unit 304 selects a communication function to be used according to the usage status of the user terminal. That is to say, an operation screen appropriate for the operation environment of the user terminal can be generated. For example, when the line status is not good due to the heavy traffic in the communication line, a data format is selected such that an operation screen using a video exchange function dealing a large amount of data is not displayed on the screen.

According to such a configuration, it is possible to display an operation screen which is appropriate for the usage status of a user terminal.

### EXAMPLES

Detailed examples of the present invention will be described below.

### First Example

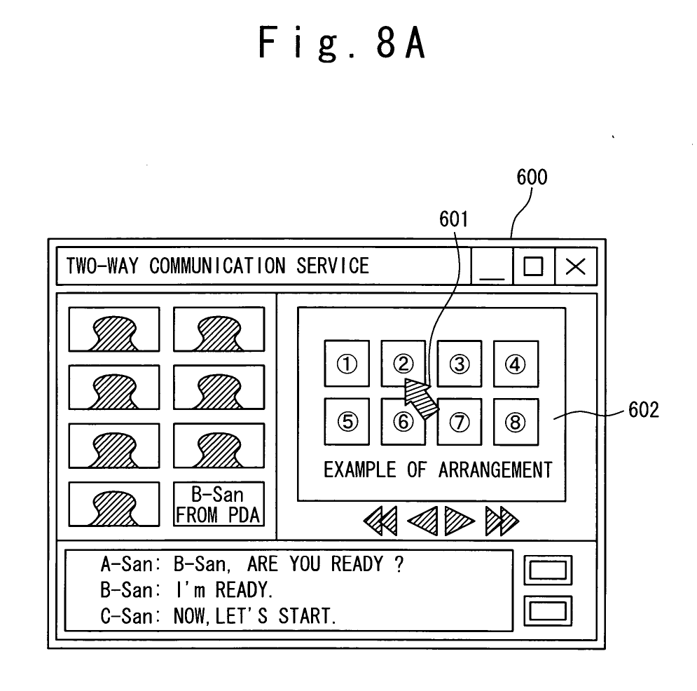

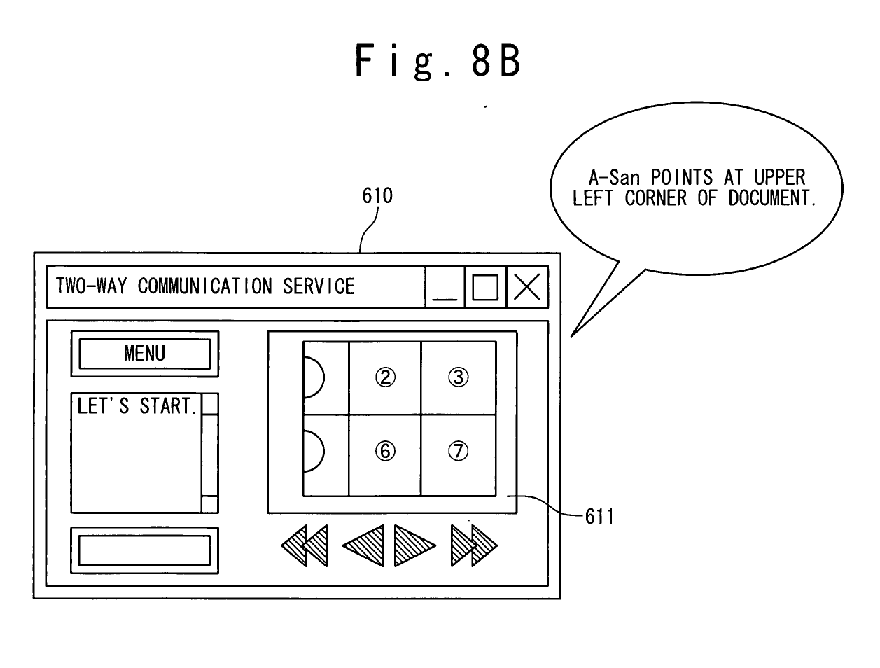

In the first example, the present invention is applied to an online electronic conference service. Here, the system shown in FIG. 3 is used. The communication server 300 is a server providing the electronic conference service. At least two users receive the electronic conference service. A “user A” uses a desktop PC as the user terminal 320 and a “user B” uses a PDA (Personal Digital Assistant) as the user terminal 330. FIG. 8A shows an example of an operation screen 600 displayed on a display of the user terminal 320. FIG. 8B shows an example of an operation screen 610 displayed on a display of the user terminal 330. The desktop PC supports an annotation function of the electronic conference service as the communication operation. On the other hand, the PDA does not support the annotation function due to the limitation of the operation environment.

The annotation function in the electronic conference service makes it easy for all users to notice which part of a conference document attention should be paid to. More specifically, when a participant moves an arrow pointer by operating a pointing device (for example, a mouse connected to the user terminal) on the conference document displayed on a terminal screen, an arrow pointer displayed on another terminal screen of another participant moves in a similar way. Thus, it becomes easier to tell a point on the conference document to which the user should pay attention.

When the use terminal 320 (desktop PC) used by the user A logs-in to the communication server 300, the environment detecting unit 302 detects that the user terminal 320 is a desktop PC and determines that the user terminal 320 supports all the functions of the electronic conference service. Also, the connecting terminal management unit 305 registers the user terminal 320 on a connecting terminal list which is a list of the user terminals the connecting terminal management unit 305 is managing.

The function selecting-synthesizing unit 304 synthesizes all the communication functions of the electronic conference service. The transmission data generating unit 306 generates data of an operation screen associated with the synthesized communication functions. The data input/output unit 301 transmits the data generated by the transmission data generating unit 306 to the user terminal 320 via the communication network 110. The application software 321 of the user terminal 320 displays the operation screen 600 on a display unit, based on the operation screen data received from the communication server 300.

When the use terminal 330 (PDA) used by the user B logs-in to the communication server 300, the environment detecting unit 302 detects that the user terminal 330 is a PDA and determines that the user terminal 330 supports a part of the functions of the electronic conference service. More specifically, the environment detecting unit 302 determines that the user terminal 330 does not support the annotation function. Also, the connecting terminal management unit 305 registers the user terminal 330 on the connecting terminal list.

The function selecting-synthesizing unit 304 synthesizes the communication functions of the electronic conference service which the user terminal 330 can use. The transmission data generating unit 306 generates data of an operation screen associated with the synthesized communication functions. The data input/output unit 301 transmits the data generated by the transmission data generating unit 306 to the user terminal 330 via the communication network 110. The application software 331 of the user terminal 330 displays the operation screen 610 on a display unit, based on the operation screen data received from the communication server 300.

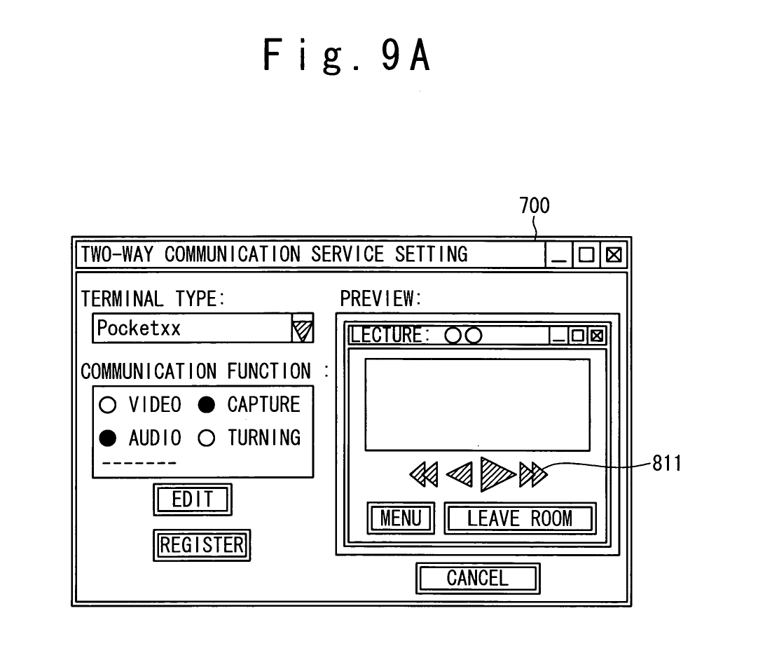

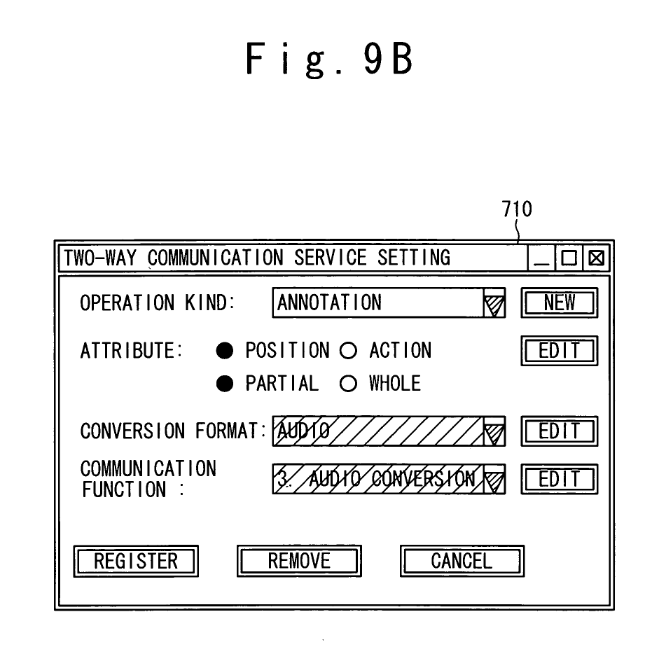

FIG. 9A shows an example of a screen layout setting screen 700 used in registering templates of the screen layout on the service information table 309. The screen layout setting screen 700 is one of functions which are implemented by the data setting interface for setting the conversion information table 308 and the service information table 309. By using the screen layout setting screen 700, an administrator of the communication server 300 can preview an operation screen when usable communication functions are synthesized.

Also, the administrator of the communication server 300 determines a configuration rule of the screen layout beforehand and registers the configuration rule on the service information table 309. For example, it is difficult for a mobile terminal such as a PDA to use a screen layout in which the whole operation screen including all the communication functions is displayed simultaneously, because the display size of the PDA is small. Therefore, a rule is determined in which a plurality of screens are switched in response to a user operation. In this case, each communication function is displayed with an appropriate size, and a screen to be displayed is switched according to the operation of a menu button. It should be noted that the administrator can change the template of the screen layout by using the screen layout setting screen 700 implemented by the data setting interface, immediately after the provision of the service starts.

FIG. 9B shows an example of a conversion information setting screen (two-way communication service setting screen) 710 used for registering applicable data formats (conversion formats) on the conversion information table 308 and for registering communication functions associated with the applicable data formats on the service information table 309. The conversion information setting screen 710 is one of the functions which are implemented by the data setting interface for setting the conversion information table 308 and the service information table 309. By using the conversion information setting screen 710, the administrator of the communication server 300 can determine for every communication operation an attribute of the communication operation, applicable data formats (conversion formats) and communication functions to be used. FIG. 9B shows an example of the conversion information setting screen 710 with regard to the annotation function. In the annotation function, it is important to notify a position where a communication operation is carried out. Therefore, to indicate a local position is set as the attribute. To be more precise, the attribute indicating the local position is “position” and “partial (local)” as shown by black circles in FIG. 9B.

By using the data setting interface, the administrator of the communication server 300 registers before hand applicable data formats appropriate for the attribute on the conversion information table 308 and also registers beforehand a combination of communication functions to be used on the service information table 309. It should be noted that the administrator can change the applicable data format, the attribute and the communication function associated with the communication operation by using the conversion information setting screen 710 implemented by the data setting interface, immediately after the provision of the service starts.

For example, in the case when the operation type is the annotation function, registered as the applicable data formats are “arrow pointer”, “image”, “audio” and “text”. Also, registered as the communication functions are an “annotation notification function”, a “document displaying function” (a function for displaying the same slide on a display of each user terminal), a “magnification function” (a function for displaying the same magnified slide on a display of each user terminal), a “snapshot function” (a function for shooting the conference with a camera connected to a user terminal and for displaying), a “video conversion function” (a function for inserting slides into a video), an “audio conversion function” (a function for announcing a position of the arrow pointer), a “text chat function” (a function for notifying a user of a position of the arrow pointer by a text) and a message function (a function for notifying a user of a position of the arrow pointer by a pop-up message). Those functions correspond to the communication functions in the annotation function as the communication operation.

When the “user A” using the user terminal 320 (desktop PC) places an arrow pointer 601 according to the annotation function of the application software 321 on a conference document 602 displayed on the operation screen 600 of the user terminal 320 as shown in FIG. 8A, the communication operation data is transmitted to the communication server 300. The status analyzing unit 303 determines that the applicable data format mentioned above is usable. The function selecting-synthesizing unit 304 checks a connection status of another user terminal of another user attending the same electronic conference and selects a communication function using an applicable data format.

The function selecting-synthesizing unit 304 determines a communication function used in place of the annotation notification function in the user terminal 330 (PDA) according to the usage status of the user terminal 330 and the priority which the user B or the administrator of the communication server 300 has determined in advance. In this case, the function selecting-synthesizing unit 304 selects the “magnification function” because attention should be paid to a local area of the conference document. Thus, a magnified conference document 611 is displayed on the operation screen 610 of the user terminal 330. When the user terminal 330 supports the “audio conversion function”, it is possible by using together the audio conversion function to output a voice saying “A-san (Mr. A or Ms. A) points at upper left corner of the document” from a speaker of the user terminal 330 (see FIG. 8B). This gives more efficient transmission of the communication operation.

Also, when the function selecting-synthesizing unit 304 judges based on the connection environment of the user terminal that substantial line can not be acquired, the function selecting-synthesizing unit can select a communication function in consideration of the load of the user terminal. Also, when determining a communication function, the function selecting-synthesizing unit 304 can determine the communication function based on the detailed terminal information by referring to the terminal information table 307.

If the user A and the user B log-out from the communication server 300, the connecting terminal management unit 305 eliminates the user terminals 320 and 330 from the connecting terminal list.

As described above, the function selecting-synthesizing unit 304 selects the communication functions appropriate for respective of the user terminals. The transmission data generating unit 306 generates the transmission data in the data formats appropriate for the user terminals. Then, the application software 321 and the application software 331 display or play the communication operation (for example, the communication operation of the annotation function) executed in another user terminal. Thus, it is possible to establish a smooth and practical two-way communication.

### Second Example

In the second example, the present invention is applied to an E-learning service. Here, the system shown in FIG. 3 is used. The communication server 300 is a server providing the E-learning service. The E-learning service is an education service by which a user can study by using a communication network.

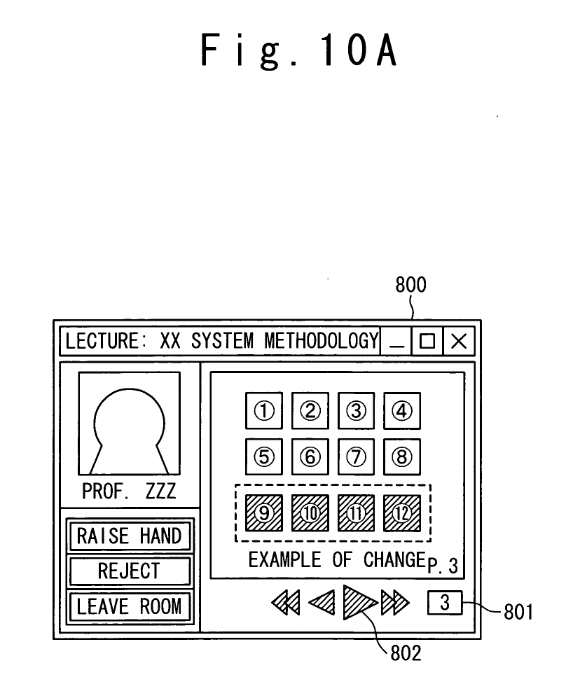

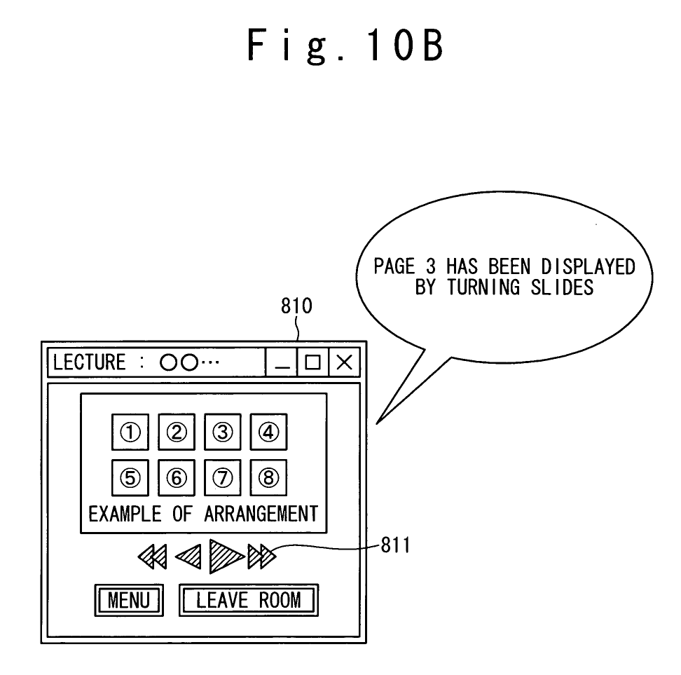

At least two users receive the E-learning service. A “user A” as a student uses a desktop PC as the user terminal 320 and a “user B” as a student uses a cell phone as the user terminal 330. FIG. 10A shows an example of an operation screen 800 displayed on a display of the user terminal 320. FIG. 10B shows an example of an operation screen 810 displayed on a display of the user terminal 330. A lecturer uses the user terminal 340 which is a desktop PC.

In this example, the desktop PC supports a slide turning notification function of the E-learning service. On the other hand, the cell phone does not support the slide turning notification function due to the limitation of the operation environment.

The slide turning notification function is a communication function used for notifying a user of which slide the lecturer is explaining. In the E-learning service, when the lecturer turns over slides of lecture document, slides of lecture document displayed on the screen of the user terminal are also turned over in a similar way.

In the slide turning notification function, it is important to notify a page being displayed at the time of an operation timing and the slide turning. By using the data setting interface, the administrator of the communication server 300 determines the attributes (ex. “Whole” of the lecture document) for the slide turning operation.

The setting with regard to the slide turning function can be done in a similar way by using the conversion information setting screen (two-way communication service setting screen) 710 shown in FIG. 9B. In the conversion information setting screen, registered as the applicable data formats associated with the slide turning function are “notification command”, “image”, “audio” and “text”. Also, registered as the communication functions are a “slide turning notification function”, a “video conversion function” (a function for inserting slides into a video), an “audio conversion function” (a function for announcing a slide turning), a “text chat function” (a function for notifying a user of a slide turning by a text) and a message function (a function for notifying a user of a slide turning by a pop-up message).

When the “user A” as a student operates the user terminal 320 (desktop PC) to log-in the communication server 300, the environment detecting unit 302 detects that the user terminal 320 is a desktop PC and determines that the user terminal 320 supports all functions of the E-learning service. Also, the connecting terminal management unit 305 registers the user terminal on the connecting terminal list.

The function selecting-synthesizing unit 304 synthesizes all the communication functions (ex. the slide turning notification function) of the E-learning service The transmission data generating unit 306 transmits an operation screen data for displaying the synthesized communication functions to the user terminal 320. The application software 321 of the user terminal 320 displays the operation screen 800 on a display of the user terminal 320.

When the “user B” as a student operates the user terminal 330 (cell phone) to log-in the communication server 300, the environment detecting unit 302 detects that the user terminal 330 is a cell-phone and determines that the user terminal 330 supports a part of the communication functions of the E-learning service. More specifically, the environment detecting unit 302 determines that the user terminal 330 does not support the slide turning notification function. Also, the connecting terminal management unit 305 registers the user terminal 330 on the connecting terminal list.

The function selecting-synthesizing unit 304 synthesizes all the communication functions of the E-learning service which the user terminal 330 supports. The transmission data generating unit 306 transmits an operation screen data associated with the synthesized communication functions to the user terminal 330. The application software 331 of the user terminal 330 displays the operation screen 810 on a display of the user terminal 330.

The lecturer using the user terminal 340 operates a pointing device (for example, a mouse) to hold down a slide turning button on a screen displayed by the application software 341. In this case, information of the communication operation is transmitted to the communication server 300. The status analyzing unit 303 determines that any of the applicable data formats mentioned above is usable. The function selecting-synthesizing unit 304 checks a connection status of another user terminal of another user attending the same E-learning service and selects a communication function using an applicable data format.

The application software 321 installed in the user terminal 320 receives the information of the slide turning which is a communication operation executed by the lecturer. Then, for example, the application software 321 blinks a slide turning button (a button for turning a page) 802 and automatically displays the next slide in the operation screen 800. Also, the application software 321 renews a slide number 802 to notify, for example, the “page 3”.

The application software 331 installed in the user terminal 330 receives information about the slide turning. Then, by using the audio conversion function, for example, the application software 331 outputs a voice saying “Page 3 has been displayed by turning slides” from a speaker of the user terminal 330 as shown in FIG. 10B, and notifies the user B that the slide display has been changed. When the user B notices the slide turning through the audio output, the user B can view the page 3 by operating the user terminal 330 to hold down a slide turning button 811 on the screen.

If the text chat function and the message function are used, the display area in the user terminal 330 is temporarily covered by the messages. From the view point of smooth communication, the audio conversion function is preferable in which the slide turning is notified by a voice with displaying the lecture document in as large area as possible. Therefore, the function selecting-synthesizing unit 304 selects the audio conversion function as a communication function for the user terminal 330 in order to efficiently display the lecture document in a very small display screen of the cell phone. It should be noted that the administrator of the communication server 300 can set such priority of function in the function selecting-synthesizing unit 304.

As described above, the application software 331 notifies the communication operation of another user (ex. page turning notification function) by using the audio output. Thus, a smooth and practical two-way communication can be established.

### Third Example

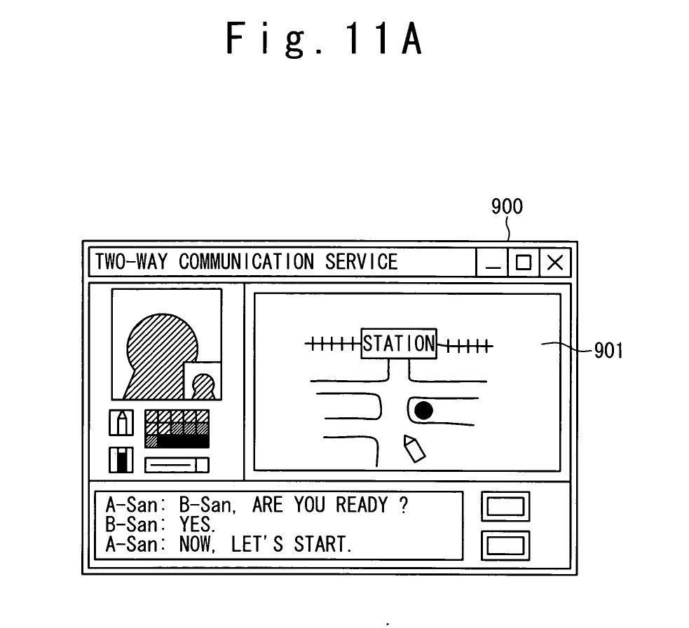

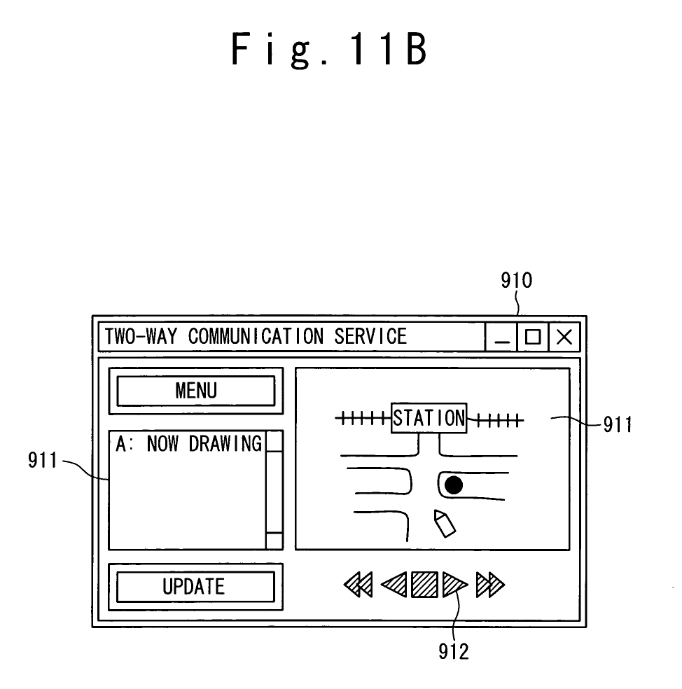

In the third example, the present invention is applied to an IP (Internet Protocol) phone service. Here, the system shown in FIG. 3 is used. The communication server 300 is a server for providing the IP phone service. At least two users receive the IP phone service. A “user A” uses a desktop PC as the user terminal 320 and a “user B” uses a PDA (Personal Digital Assistant) as the user terminal 330. FIG. 11A shows an example of an operation screen 900 displayed on a display of the user terminal 320. FIG. 11B shows an example of an operation screen 910 displayed on a display of the user terminal 330.

The desktop PC supports a whiteboard function of the IP phone service. On the other hand, the PDA does not support the white board function due to the limitation of the operation environment.

The whiteboard function is a visual communication function for communicating in a free expression. According to the whiteboard function, the process and content of a drawing on a screen of one user terminal are also drawn on a screen of another user terminal in a similar way.

In the whiteboard function, it is important to notify the timing of the communication operation and who is drawing. The administrator of the communication server 300 determines the attribute such that images under drawing are transmitted momentarily and the whole picture is shown after the drawing is completed.

In the case of the whiteboard function, for example, registered as the applicable data formats are “drawing command”, “image”, “audio” and “text”. Also, registered as the communication functions are a “whiteboard f function”, a “snapshot function” (a function for storing a picture under drawing as a still picture), an “audio conversion function” (a function for announcing a content of a drawing to a user), a “text chat function” (a function for notifying a user of a content of a drawing by a text) and a message function (a function for displaying the drawing user in a message area of a screen of each user terminal).

When the use terminal 320 (desktop PC) used by the user A logs-in to the communication server 300, the environment detecting unit 302 detects that the user terminal 320 is a desktop PC and determines that the user terminal 320 supports all the functions of the IP phone service. Also, the connecting terminal management unit 305 registers the user terminal 320 on the connecting terminal list.

The function selecting-synthesizing unit 304 synthesizes all the communication functions (ex. the whiteboard function) of the IP phone service. The transmission data generating unit 306 generates an operation screen data associated with the synthesized communication functions. The application software 321 of the user terminal 320 displays the operation screen 900 on a display unit of the user terminal 320.

When the use terminal 330 (PDA) used by the user B logs-in to the communication server 300, the environment detecting unit 302 detects that the user terminal 330 is a PDA and determines that the user terminal 330 supports a part of the communication functions of the IP phone service. More specifically, the environment detecting unit 302 determines that the user terminal 330 does not support the whiteboard function. Also, the connecting terminal management unit 305 registers the user terminal 330 on the connecting terminal list.

The function selecting-synthesizing unit 304 synthesizes the communication functions of the IP phone service which the user terminal 330 can use. The transmission data generating unit 306 generates an operation screen data associated with the synthesized communication functions. The application software 331 of the user terminal 330 displays the operation screen 910 on a display unit of the user terminal 330.

After the user terminal 320 and the user terminal 330 are connected via the communication server 300, the user A draws on a whiteboard 901 by using a pointing device such as a mouse connected to the user terminal 320 by using the whiteboard function of the application software 321. In this case, data of the drawing operations are momentarily transmitted to the communication server 300. The status analyzing unit 303 determines that any of the applicable data formats mentioned above is usable. The function selecting-synthesizing unit 304 checks the connecting terminal information of respective of the user terminals, and selects communication functions using applicable data formats which can be used in respective of the user terminals. The transmission data generating unit 306 transmits the communication operation data to respective of the user terminals by using the communication functions selected by the function selecting-synthesizing unit 304.

The application software 321 installed in the user terminal 320 displays the contents of the drawing momentarily by using the whiteboard function.

The application software 331 installed in the user terminal 330 captures the contents of the drawing by the user A in a predetermined interval by using the snapshot function, and displays a captured image on a capture screen 911. The application software 331 displays captured images successively in a predetermined interval, which makes it possible to reconstruct the drawing operations by the user A. It is also possible for the application software 331 to switch the capture screen in response to push down of a capture screen turning button 912.

Also, when a plurality of users make drawing, itis useful to display a text information in the message area 911 which indicates association between the users and colors.

As described above, the application software 331 notifies the communication operation of another user (ex. whiteboard function) by using still pictures. Thus, a smooth and practical two-way communication can be established.

The present invention can be applied to systems providing a two-way communication service (electronic conference, help desk, contact center, remote consultation, IP phone, P2P collaboration tool, net game, net shopping, virtual mall, E-learning and so on) which is used between a plurality of terminals through a communication network.

It will be obvious to one skilled in the art that the present invention may be practiced in other embodiments that depart from the above-described specific details. The scope of the present invention, therefore, should be determined by the following claims.

1. A system for providing communication service comprising:
a communication server;
a plurality of user terminals connected to said communication server via a communication network;
a connection management unit detecting information about an operation environment of each of said plurality of user terminals;
a service control unit analyzing a meaning of a communication operation received from one of said plurality of user terminals and determining an applicable data format used for transmitting said communication operation to another of said plurality of user terminals according to said operation environment of said another user terminal; and
a data generating unit generating transmission data to be provided for said another user terminal based on said applicable data format determined by said service control unit.

2. The system according to claim 1,
wherein said connection management unit includes:
an environment detecting unit detecting said operation environment of each of said plurality of user terminals; and
a connecting terminal management unit managing a connection status of said each user terminal with said communication network,
said service control unit includes:
a status analyzing unit analyzing said meaning of said communication operation received from said one user terminal; and
a function selecting-synthesizing unit selecting a communication function used for expressing said meaning of said communication operation in said another user terminal according to said operation environment of said another user terminal, and
said data generating unit includes a communication function data generating unit generating said transmission data based on said communication function selected by said function selecting-synthesizing unit.

3. The system according to claim 2,
wherein said plurality of user terminals include user terminals having different performances,
said function selecting-synthesizing unit selects a plurality of said communication functions which are usable in said another user terminal according to said operation environment of said another user terminal, and synthesizes said plurality of communication functions, and
said communication function data generating unit generates a screen data for displaying a combination of said plurality of communication functions.

4. The system according to claim 2, further comprising:
a terminal information setting interface for setting terminal information indicating said operation environment of each of said plurality of user terminals;
a conversion information setting interface for setting said applicable data format;
a service information setting interface for setting association between said applicable data format and said communication function; and
a screen layout setting interface for setting a screen layout in said each user terminal.

5. The system according to claim 4, further comprising:
a terminal information managing interface for managing said terminal information;
a conversion information managing interface for managing said applicable data format;
a service information managing interface for managing said association between said applicable data format and said communication function; and
a screen layout managing interface for managing said screen layout.

6. The system according to claim 5,
wherein said conversion information managing interface is used for registering an attribute of said communication operation.

7. The system according to claim 5,
wherein said service information managing interface sets priority for said communication function according to said operation environment.

8. The system according to claim 3, further comprising:
a terminal information setting interface for setting terminal information indicating said operation environment of each of said plurality of user terminals;
a conversion information setting interface for setting said applicable data format;
a service information setting interface for setting association between said applicable data format and said communication function; and
a screen layout setting interface for setting a screen layout in said each user terminal.

9. The system according to claim 8,
wherein said screen layout setting interface sets said screen layout according to said combination of said plurality of communication functions.

10. The system according to claim 2,
wherein said communication function data generating unit is provided in each of said plurality of user terminals.

11. The system according to claim 10,
wherein said status analyzing unit and said function selecting-synthesizing unit are provided in each of said plurality of user terminals.

12. A method of providing communication service in a communication service providing system,
said communication service providing system including a communication server and a plurality of user terminals connected to said communication server via a communication network,
said method comprising:
(A) said communication server storing terminal information indicative of operation environments of respective of said plurality of user terminals in a memory unit;
(B) when one of said plurality of user terminals logs-in said communication server, said communication server retrieving an operation environment of said one user terminal from said terminal information stored in said memory unit; and
(C) said communication server selecting a communication function used for expressing a communication operation executed by said one user terminal in another of said plurality of user terminals according to another operation environment of said another user terminal.

13. The method according to claim 12,
wherein, in said (C) selecting, said communication server converts said communication operation executed by said one user terminal into a data format associated with said communication function supported by said another user terminal.

14. The method according to claim 12,
wherein said (C) selecting includes:
(C1) abstracting meanings of respective of a plurality of communication operations by using at least one attribute;
(C2) determining an attribute associated with said communication operation executed by said one user terminal; and
(C3) determining based on said attribute a data format associated with said communication function which is supported by said another user terminal and used for expressing said communication operation in said another user terminal.

15. The method according to claim 14, further comprising
(a) said communication server storing a plurality of data formats associated with each of a plurality of communication functions in said memory unit,
wherein, in said (C3) determining, said data format used for expressing said communication operation is selected from said plurality of data formats.

16. The method according to claim 15,
wherein one data format which is most appropriate for said another operation environment of said another user terminal is specified as said data format.

17. The method according to claim 15,
wherein one data format which is most appropriate for a usage status of said another user terminal is specified as said data format.

18. The method according to claim 12,
wherein said plurality of user terminals receiving a same communication service is managed as one community group.

19. The method according to claim 12,
wherein a layout of an operation screen of said another user terminal is automatically generated according to a combination of communication functions supported by said another user terminal.

20. The method according to claim 19,
wherein said layout is generated according to a combination of communication functions selected by a user.

21. The method according to claim 12,
wherein, if terminal information of said one user terminal is not stored in said memory unit when said one user terminal logs-in said communication server, said communication server requires said one user terminal to transmit terminal information of said one user terminal at a time of next data transmission, and stores said terminal information in said memory unit.

22. The method according to claim 12,
wherein said communication server has a translation program,
said one user terminal transmits said communication operation in a dedicated language, and
said communication server interprets a meaning of said communication operation by executing said translation program.

23. The method according to claim 14,
wherein, if said communication server receives a plurality of communication operations successively from said one user terminal, said communication server selects one data format synthesizing said plurality of communication operations as said data format.

24. The method according to claim 14,
wherein said communication server determines a data type of information about said communication operation and selects said data format according to said data type determined.

25. The method according to claim 15,
wherein, if a plurality of data formats are selected, said data format is specified from said plurality of data formats according to a predetermined priority.

26. A communication server, which is connected to a plurality of user terminals via a communication network and provides a communication service for each of the plurality of user terminals, comprising:
a connection management unit detecting information about an operation environment of each of said plurality of user terminals;
a service control unit analyzing a meaning of a communication operation received from one of said plurality of user terminals and determining an applicable data format used for transmitting said communication operation to another of said plurality of user terminals according to said operation environment of said another user terminal; and
a data generating unit generating transmission data to be provided for said another user terminal based on said applicable data format determined by said service control unit.

27. The communication server according to claim 26, wherein said connection management unit includes:
an environment detecting unit detecting said operation environment of each of said plurality of user terminals; and
a connecting terminal management unit managing a connection status of said each user terminal with said communication network,
said service control unit includes:
a status analyzing unit analyzing said meaning of said communication operation received from said one user terminal; and
a function selecting-synthesizing unit selecting a communication function used for expressing said mean ing of said communication operation in said another user terminal according to said operation environment of said another user terminal, and
said data generating unit includes a communication function data generating unit generating said transmission data based on said communication function selected by said function selecting-synthesizing unit.

28. The communication server according to claim 27,
wherein said function selecting-synthesizing unit selects a plurality of said communication functions which are usable in said another user terminal according to said operation environment of said another user terminal, and synthesizes said plurality of communication functions, and
said communication function data generating unit generates a screen data for displaying a combination of said plurality of communication functions.

29. A computer program product, which is implemented in a communication server connected to a plurality of user terminals via a communication network,
said computer program product comprising:
computer readable code configured to cause said communication server to detect information about an operation environment of each of said plurality of user terminals;
computer readable code configured to cause said communication server to analyze a meaning of a communication operation received from one of said plurality of user terminals and determine an applicable data format used for transmitting said communication operation to another of said plurality of user terminals according to said operation environment of said another user terminal; and
computer readable code configured to cause said communication server to generate transmission data to be provided for said another user terminal based on said applicable data format.

30. A computer program product, which is implemented in a communication server connected to a plurality of user terminals via a communication network,
said computer program product comprising:
computer readable code configured to cause said communication server to detect an operation environment of each of said plurality of user terminals;
computer readable code configured to cause said communication server to manage a connection status of said each user terminal with said communication network;
computer readable code configured to cause said communication server to analyze a meaning of a communication operation transmitted from said each user terminal;
computer readable code configured to cause said communication server to select a communication function used for expressing said meaning of said communication operation according to said operation environment of said each user terminal; and
computer readable code configured to generate transmission data based on said selected communication function.
